(19) United States
(12) Patent Application Publication
(10) Pub. No.: US 2024/0035180 A1
(43) Pub. Date: Feb. 1, 2024

(54) SEPARATOR PLATE FOR AN ELECTROCHEMICAL SYSTEM

(71) Applicant: Reinz-Dichtungs-GmbH, Neu-Ulm (DE)

(72) Inventors: Christoph SPECHT, Neu-Ulm (DE); Jonas LEISCHER, Neu-Ulm (DE); Wolfgang NIKOLAUS, Neu-Ulm (DE); Tim DANIEL, Neu-Ulm (DE)

(21) Appl. No.: 18/359,714

(22) Filed: Jul. 26, 2023

(30) Foreign Application Priority Data
Jul. 27, 2022 (DE) 20 2022 104 245.4

(51) Int. Cl. C25B 13/02; H01M 8/0297; H01M 8/0258; H01M 8/18

(52) U.S. Cl. CPC C25B 13/02; H01M 8/0297; H01M 8/0258; H01M 8/188; H01M 2008/1095

(57) ABSTRACT

A separator plate is disclosed for an electrochemical system. The plate comprises a multitude of mutually parallel and adjacent channels that are designed to guide a fluid at least along a region of the separator plate, wherein the channels each have a depth, a longitudinal extent, a channel base and two sidewalls, wherein the following conditions apply to at least one of the channels: the depth of the channel in a first region of the channel is essentially constant along the longitudinal extent, the channel base in the first region of the channel is essentially flat and the depth of the channel in a transition region of the channel that adjoins the first region decreases along the longitudinal extent, as a result of which a channel base continuation in the transition region is curved.

### CROSS-REFERENCE TO RELATED APPLICATION

The present application claims priority to German Utility Model Application 20 2022 104 245.4, entitled “SEPARATOR PLATE FOR AN ELECTROCHEMICAL SYSTEM”, and filed on Jul. 27, 2022. The entire contents of the above-listed application is hereby incorporated by reference for all purposes.

### TECHNICAL FIELD

The present disclosure relates to a separator plate for an electrochemical system and to an electrochemical system. The electrochemical system may, for example, be a fuel cell system, an electrochemical compressor, a redox flow battery or an electrolyzer.

### BACKGROUND AND SUMMARY

Known electrochemical systems typically comprise a multitude of separator plates arranged in a stack, such that any two adjacent separator plates form an electrochemical cell. An electrochemical cell usually comprises a membrane provided with electrodes and a catalyst layer, referred to collectively as membrane electrode assembly (MEA), which is generally surrounded on the outside of the active region by a reinforcement layer or a cell frame, and optionally by gas diffusion layers (GDL) or porous transport layers (PTL) that face the separator plates, and optionally by layers of sintered metal or mesh layers that serve e.g. for pressure distribution.

The separator plates may serve, for example, for electrical contacting of the electrodes of the individual electrochemical cells (e.g. fuel cells or electrolyzer cells) and/or for electrical connection of adjacent cells (series connection of the cells). The separator plates may also serve to dissipate heat that arises in the cells between the separator plates. Such waste heat may arise, for instance, in the conversion of electrical or chemical energy in a fuel cell. In fuel cells, bipolar plates are usually used, which in turn usually each comprise two separator plates that are connected to one another along their reverse sides that face away from the electrochemical cells. In electrolyzers, the separator plates, by contrast, may each also have just a single plate, optionally in combination with one or more frame elements.

Usually, the separator plates each have at least one passage opening. In the separator plate stack of the electrochemical system, the passage openings of the stacked separator plates, which are in a flush or at least partly overlapping arrangement, then form media channels for media supply or for media removal. For sealing of the passage openings or of the media channels formed by the passage openings of the separator plates, known separator plates often have elastomer arrangements and/or crimped arrangements that are each arranged around the pas sage opening of the separator plate in the plate itself or have been applied to the plate in this region.

The separator plates may also have channel structures for supply of an electrochemically active region of the separator plate with one or more media and/or for outward transport of media. The electrochemically active region may, for example, include or bound an electrochemical cell. The media in the case of a fuel cell may, for example, be fuels (e.g. hydrogen or methanol), reaction gases (e.g. air or oxygen) or a coolant as media supplied, and reaction products and heated coolant as media removed. In fuel cells, the reaction media, e.g. fuel and reaction gases, are typically conducted on the outward-facing surfaces of the two separator plates connected to one another, while the coolant is conducted between the separator plates. The media in the case of an electrolyzer may, for example, be water as medium supplied, and hydrogen and a mixture of oxygen and water as media removed. Some of the hydrogen is often circulated in order to avoid contamination of the system.

Channels of this kind are separated from one another by lands, so as to give rise to a sequence of lands and of channels separated from one another by lands transverse to the flow direction of the fluid. In the case of fuel cells, there is merely a shroud of the MEA opposite the distribution region that serves to supply the active region and opposite the collecting region that serves for removal from the active region, whereas the MEA itself and the GDLs are disposed between the separator plates in the actually active region. In an intermediate region, the MEA shroud overlaps with the actual membrane including electrodes and catalyst, and the GDL also projects into this intermediate region, such that there is a greater material thickness in this intermediate region than in the active region and in the distribution region and/or collection region. In the case of electrolyzers, it is possible to distinguish either two or three regions of this kind, wherein channels extend. The separator plates may each have a transition region between the regions adjoining one another that are mentioned in this section.

Because of the arrangement of the passage openings and channels in/on the plates, some of the channels and lands in many separator plates end at or in the transition regions. At the ends of the channels where the respective channel base is transformed into the plane of the respective separator plate which is adjacent to the channels, material stresses often occur, and significant material thinning of the channel walls because of the very significant warpage of the plate material there on embossing of the channels. Because of the high degree of forming, cracks can even occur in some places. Material thinning leads to a shorter service life of the separator plate; severe material thinning and cracks lead to a higher reject rate in the manufacture of separator plates.

By virtue of the embossing process, the material is additionally curved in two different directions at the channel ends. Firstly, the wall of the channel is curved transverse to the longitudinal direction of the channel in cross section, and secondly also curved in the direction of the longitudinal extent. Because of the relatively small embossment radius at the end of the channel, this leads to relatively significant reshaping of the channel end.

It is therefore an object of the present disclosure to provide a separator plate that has a longer service life and has higher process stability and a reduced reject rate in manufacture. It is a further object of the present disclosure to provide an electrochemical system having such a separator plate.

This object is achieved by the separator plate and the electrochemical system according to the independent claims. Advantageous developments are specified in the respective dependent claims and in the description that follows.

In a first aspect, a separator plate for an electrochemical system is proposed. The separator plate comprises a multitude of mutually parallel and adjacent channels that are designed to guide a fluid at least along a region of the separator plate. The channels each have a depth, a longitudinal extent, a channel base and two sidewalls, wherein the following conditions apply to at least one of the channels:
the depth of the channel in a first region of the channel is essentially constant along the longitudinal extent,
the channel base in the first region of the channel is essentially flat and
the depth of the channel in a transition region of the channel that adjoins the first region decreases along the longitudinal extent, as a result of which a channel base continuation in the transition region is curved.

The channel base continuation in the transition region is curved in such a way that, when surface lines of the channel base that are mutually parallel to one another along the longitudinal extent of the channel and in the first region are continued in the region of the channel base continuation, the surface lines likewise run essentially parallel to one another in the region of the channel base continuation. The abovementioned properties may be applicable not just to one channel but to a multitude of channels.

The words “essentially parallel” are supposed to mean here in the context of the present document that, in real plates, variances from parallelism of not more than 12°, especially not more than 10°, not more than 8°, typically not more than 6°, generally not more than 4°, in some embodiments not more than 2°, are possible. Such variances from parallelism may arise, for example, from the fact that, with decreasing depth of the channel, the width of the channel, more specifically of the continuation of the channel base, can easily increase for process-related reasons because of the lower embossment height. It may be the case that the variances mentioned are applicable to any two surface lines from all the surface lines of the channel. The variances mentioned may be applicable to two surface lines of the channel that are as far as possible removed from one another.

By virtue of the surface lines, in accordance with the present disclosure, running essentially parallel to one another in the channel base continuation as well, the material of the separator plate in this region undergoes curvature in the same direction, as a result of which a degree of forming in this region is reduced by comparison with channels of conventional separator plates, in which the channel end has a round or curved, for example hemispherical, progression in top view. In this way, the separator plate is thinned to a lesser degree in this region than if the surface lines diverge and the material is curved in different directions. Thus, the plate material may have a more uniform thickness and/or a minimum thickness can be better maintained. Moreover, in the case of curvature in the same direction or in the case of a reduced level of forming, stresses in the material can be reduced. Overall, it is thus possible to reduce excessive material thinning and/or cracking at the channel ends, and it is thus possible to increase the service life of the separator plate. It is also possible to achieve a lower reject rate in the manufacture of separator plates.

Usually, the properties described above are satisfied for a multitude of channels, for example at least 10, 20, 50 or 100, or even for all channels, of the separator plate. The channels may have at least a first channel(s) and at least a second channel(s), each of which have the above-defined properties.

The following condition may be applicable to the at least one first channel: the transition region forms an end section of the channel and adjoins an essentially flat, especially non-embossed, region of the separator plate. The flat region of the separator plate, because of further embossed elements in the separator plate, may have an areal extent of not more than 50 mm², for example not more than 20 mm².

The following condition may be applicable to the at least one second channel: the transition region adjoins a second region of the channel or a further channel, is disposed between the first region and the second region or the further channel and connects the two fluidically to one another. It is possible here for a depth of the channel in the second region or a depth of the further channel to be lower than the depth of the channel in the first region. In this case, the transition region thus forms a fluidic transition from the lower first region to the flatter second region or to the flatter further channel.

Especially in the case of fuel cells, firstly, the active region may form a first region and an intermediate region a second region; alternatively or additionally, it is possible here that the distribution region and/or collection region forms a first region and an intermediate region forms a second region. Especially when there is no intermediate region or the intermediate region forms a transition region, the distribution region and/or collection region may form a first region and the active region forms a second region. In the case of electrolyzers, by contrast, the first region advantageously extends within the active region, and the second region may constitute a distribution or collection region.

The separator plate may thus have a multitude of first channels and a multitude of second channels. It may be the case, for example in fuel cells, that at least two mutually closest second channels are separated from one another by at least one first channel. Frequently, however, two or more or even all mutually closest second channels are separated from one another by at least one first channel. It is often the case that two or more first channels are arranged between two mutually closest second channels. In the case of electrolyzers, it may also be the case that multiple second channels are arranged immediately adjacent to one another and at least one first channel is disposed between such groups.

It may be the case that the channel has a straight or curved progression at least in sections along its longitudinal extent in the first region and/or in the transition region. A direction of progression of the channel is typically described here along the plane of the plate; any component of the progression at right angles to the plane of the plates—e.g. the depth or height of the channel—is neglected here. There may be a curvature of the channel base continuation here solely or at least as a result of the decreasing depth of the channel in the transition region; in the absence of any further curvature, this appears to be symmetric to both sides of the center line of the channel base in a top view onto the plane of the plate. In this first embodiment, the channel base continuation is curved in the transition region in only one direction, mainly at right angles to the plane of the plate. It may be the case that the channel base continuation is additionally curved in the direction at right angles to the longitudinal extent of the channel. An asymmetric form is apparent here in the top view of the channel. It may be the case that a circumferential line of the channel in the region of the channel base continuation has a straight section; in a first channel, such a straight section may extend especially at the end of the channel and at an angle, especially at right angles, to the longitudinal extent of the channel or channel base continuation.

Optionally, the surface lines in the region of the channel base continuation have an essentially equal length. This may occur, for example, when the channel base continuation is curved in only one direction.

In some embodiments, a curvature of the channel base continuation is essentially constant in the direction at right angles to the plane of the plate. Typically, such a radius of curvature of the channel base continuation is especially at least 0.1 mm, especially 0.15 mm, especially 0.2 mm, and/or at most 4 mm, especially at most 2.5 mm.

An essential detail in all these descriptions is that the respective dimensions and radii state the radius of the separator plate on the inside of the channel. Because of the material thickness of the plate, the external radius on the outside of the separator plate with respect to the channel may have different values.

Unlike the channel base continuation, sidewall continuations of the sidewalls in the transition region of the channel may each be curved in at least two directions at least in sections. Each sidewall in the first region may have a first curved region which, in a transverse extent of the channel, adjoins the channel base transverse to the longitudinal extent and is curved in transverse extent. When surface lines that are mutually parallel along the longitudinal extent of the channel and in the first curved region are continued in the region of the sidewall continuations, the surface lines may diverge in the region of the sidewall continuations. The surface lines may then especially each have a different length. Optionally, the respective sidewall in the first region of the channel has a connecting region and a second curved region. The first curved region and the second curved region often have different radii of curvature. The second curved region may adjoin a flat, especially non-embossed, region of the separator plate. The connecting region extends between the first curved region and the second curved region and connects the two to one another. The connecting region may be designed as a flat inclined face or inclined face having low curvature.

The channel base continuation in the transition region may have a length projected into the plane of the plate of at least 0.1 mm, at least 0.2 mm, and/or at most 4 mm and at most 2 mm, and/or have a constant width of at least 0.01 mm, at least 0.05 mm, especially at least 0.08 mm, and/or at most 5 mm, at most 3 mm, at most 2 mm, especially at most 1.8 mm.

Optionally, a radius of curvature of one of the sidewall continuations in the direction of the longitudinal extent of the channel is at least 0.1 mm, at least 0.15 mm, especially at least 0.2 mm, and/or at most 1.5 mm, especially at most 1.0 mm. Moreover, a radius of the curvature of the sidewall continuation in the direction of the transverse extent of the channel may be at least 0.1 mm, at least 0.15 mm, and/or at most 3 mm, especially at most 1.5 mm.

The channel in the first region may have a width which is determined at half the depth of the channel. For example, the length of the transition region may be greater than, equal to or less than the width of the channel. The specific ratio of width to length may depend on the construction space available and on other factors that determine the overall construction. It may also be the case that, in a two-layer bipolar plate, the separator plates that form the anode plates and cathode plates are different in this regard. The width of the channel in the first region may be somewhat less than in the second region. The width of the channel may also be somewhat less than a width of the further channel. The expression “somewhat lesser width” here shall include a decrease in width of not more than 10%. The decrease in width may, as indicated above, originate from the fact that a flat channel, for process-related reasons, has a somewhat greater width than a deep channel. In other embodiments, the width of the channel in the second region may also be much greater than in the first region, for example at least 50%, at least 75%, at least 100% or at least 125% wider. This is the case especially when the total number of channels in the second region is greatly reduced compared to the total number of channels in the first region, for instance because the number of first channels is much greater than the number of second channels.

The separator plate may have at least one passage opening for passage of a fluid and an electrochemically active region. The passage opening may be configured for passage of a reaction medium, a reaction product, and optionally a coolant, especially a cooling liquid. A passage opening may form an inlet opening or feed opening, or an outlet opening or removal opening, for the fluid. The channels may be designed for
feeding the fluid to the passage opening,
removing the fluid from the passage opening and/or
guiding the fluid along the electrochemically active region.

The electrochemically active region mentioned is sometimes referred to hereinafter as active region for the sake of simplicity. There is frequently a distribution region or collection region provided between the passage opening and the active region, in order to distribute or collect the fluid. It should be mentioned here that the active region usually takes up a majority of the area of the separator plate. The fluid thus flows typically from the input passage opening through a distribution region to the active region. The fluid is then generally collected by the collecting region at the end of the active region and then directed to the output passage opening.

The distribution region, the active region and the collection region have the channels mentioned for conducting the fluid. Between the distribution region and the active region and between the active region and the collection region, e.g. in intermediate regions, the channels of the distribution region and of the electrochemically active region, and of the active region and of the collecting region, merge into one another. Some of the channels may be interconverted, combined and/or separated into further channels. It may be the case that the active region has the first regions of the channels, especially only the first regions, while the second regions or the further channels are provided in the distribution or collection region. As elucidated above, the channels or channel sections in the intermediate region, especially in a variant as a fuel cell, as a result of the layers of GDL, membrane and MEA shroud that lie on top there, may have a smaller depth than the channels or channel sections in the active region, distribution region and/or collection region.

For the transition region, various scenarios are conceivable, where at least one of these scenarios may exist in the separator plate of this document:
the transition region forms the immediate transition from the distribution region to the active region or the transition from the active region to the collection region;
the transition region forms the transition from the distribution region to the lowered intermediate region and/or
the transition region forms the transition from the active region to the lowered intermediate region.
the channels are often shaped into the separator plate, for instance by hydroforming, thermoforming or embossing, especially vertical embossing or roll embossing.

For example, when the separator plate is used in a fuel cell, two separator plates may be combined to form a two-layer bipolar plate, in which case there is often a cooling space for accommodating a coolant provided between the separator plates of the bipolar plate. In an application as an electrolyzer, the separator plates are frequently incorporated as a single layer between the cells.

In a further aspect, a bipolar plate having two mutually connected separator plates is provided, and at least one of the two separator plates is configured in the manner described above. One of the two separator plates may be designed as the anode plate, while the other of the two separator plates is typically configured as a cathode plate. The anode plate and the cathode plate are disposed adjacent to one another to form a contact face between the mutually facing surfaces of the anode plate and of the cathode plate. Advantageously, the anode plates and cathode plates are cohesively and sealingly bonded, for example welded, to one another at least along their circumferential edge.

In a further aspect, an electrochemical system is provided. The electrochemical system comprises a multitude of stacked separator plates of the type described above. In the case of a fuel cell system, the electrochemical system may have a multitude of stacked separator plates in the form of separator plates combined to form bipolar plates.

Working examples of the separator plate and of the electrochemical system are shown in the figures and are elucidated in detail in the description that follows.

### BRIEF DESCRIPTION OF THE FIGURES

FIG. 1 a schematic perspective diagram of an electrochemical system having a multitude of separator plates or bipolar plates arranged in a stack.

FIG. 2 a schematic perspective view of two bipolar plates each consisting of two separator plates in a fuel cell with a membrane electrode assembly (MEA) disposed between the bipolar plates.

FIG. 3 one example of a separator plate in a top view of a detail.

FIG. 4 a schematic perspective view of two separator plates of an electrolyzer with a membrane electrode assembly (MEA) disposed between the separator plates.

FIG. 5 a schematic perspective view of a reverse side of a channel for conducting a fluid along part of a separator plate.

FIG. 6 a schematic side view of the channel of FIG. 5.

FIG. 7 a schematic top view of a multitude of channels.

FIG. 8 a schematic perspective view of the channels of FIG. 7.

FIG. 9 a schematic side view of a further channel.

FIG. 10 a schematic top view of the channel of FIG. 9.

FIG. 11 a schematic top view of a multitude of further channels.

FIG. 12 a schematic top view of a multitude of further channels.

FIG. 13 a schematic top view of a multitude of further channels.

### DETAILED DESCRIPTION

Here and hereinafter, features that recur in different figures are each identified by the same or similar reference numerals.

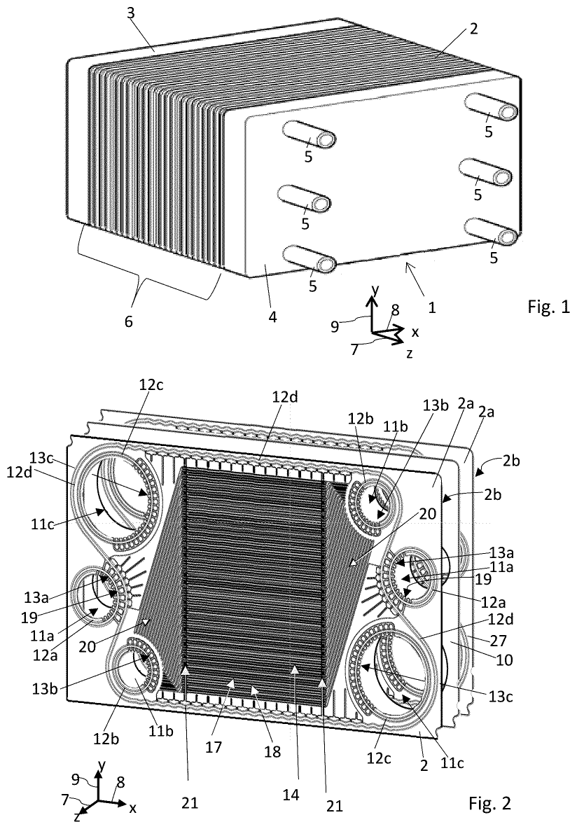

FIG. 1 shows an electrochemical system 1 having a multitude of identical metallic separator plates 2 or having a multitude of identical bipolar plates each consisting of two metallic separator plates 2 that are arranged in a stack 6 and stacked in a z direction 7. The separator plates 2 of the stack 6 are typically clamped between two end plates 3, 4. The z direction 7 is also called stacking direction. In the present example, the system 1 is a fuel cell stack. Every two adjacent separator plates 2 of the stack thus bound an electrochemical cell which serves, for example, to convert chemical energy to electrical energy. For formation of the electrochemical cells of the system 1, a membrane electrode assembly (MEA) 10 is disposed in each case between adjacent separator plates 2 of the stack (see, for example, FIG. 2). Each MEA 10 typically includes at least one membrane, for example an electrolyte membrane. In addition, a gas diffusion layer (GDL) may be disposed on one or both surfaces of the MEA. The MEA 10 also often comprises a frame-like reinforcing layer which frames and reinforces the electrolyte membrane. The reinforcing layer is generally electrically insulating and, in operation of the electrochemical system 1, prevents a short circuit.

The z axis 7 together with an x axis 8 and a y axis 9 forms a right-handed Cartesian coordinate system. The separator plates 2 each define a plane of a plate, where the planes of the separator plates are each aligned parallel to the x-y plane and hence at right angles to the stacking direction or to the z axis 7. The end plate 4 generally has a multitude of media connections 5 via which media can be supplied to the system 1 and via which media can be removed from the system 1, where the media connections 5 are sometimes referred to as ports. These media that can be supplied to the system 1 and removed from the system 1 may, for example, be fuels such as molecular hydrogen or methanol, reaction gases such as air or oxygen, reaction products such as steam or depleted fuels, or coolants such as water and/or glycol.

FIG. 2 shows a perspective view of two adjacent bipolar plates 27 each consisting of two separator plates 2a, 2b that are known from the prior art in an electrochemical system of the type of system 1 from FIG. 1, and a membrane electrode assembly (MEA) 10 which is likewise known from the prior art, disposed between these adjacent separator plates 2, where the MEA 10 in FIG. 2 is for the most part concealed by the bipolar plate 27 that faces the viewer. The bipolar plate 27 is formed from two cohesively joined separator plates 2a, 2b, of which, in FIG. 2, in each case only the first separator plate 2a facing the viewer is visible, which conceals the second separator plate 2b. The separator plates 2a, 2b may each have been manufactured from a sheet of metal, for example a sheet of stainless steel. The separator plates 2a, 2b may have been welded to one another, for example along their outer edge, for example by laser weld bonds.

The separator plates 2a, 2b typically have passage openings that are flush with one another, which form passage openings 11a-c of the bipolar plate 27. In the case of stacking of a multitude of bipolar plates 27 consisting of separator plates of the type of the separator plate 2, or of separator plates of the type of separator plate 2, the passage openings 11a-c form conduits that extend through the stack 6 in stacking direction 7 (see FIG. 1). Typically, each of the conduits formed by the passage openings 11a-c is in fluid connection with one of the ports 5 in the end plate 4 of the system 1. The conduits formed by the passage openings 11a can be used, for example, to introduce coolant into the stack 6, while the coolant is led off from the stack via other passage openings 11a. The conduits formed by the passage openings 11b, 11c, by contrast, may be designed to supply the electrochemical cells of the fuel cell stack 6 of the system 1 with fuel and with reaction gas, and to discharge the reaction products from the stack. The media-conducting passage openings 11a-c are formed essentially parallel to the plane of the plate.

In order to seal the passage openings 11a-c with respect to the interior of the stack 6 and with respect to the environment, the first separator plates 2a each have sealing arrangements in the form of sealing crimps 12a-c that are each arranged around the passage openings 11a-c and each fully enclose the passage openings 11a-c. The second separator plates 2b have, on the reverse side of the bipolar plates 27 that faces away from the viewer of FIG. 2, corresponding sealing crimps for sealing of the passage openings 11a-c (not shown). A crimp arrangement 12 of the bipolar plate 27 may be regarded as a combination of two interacting sealing crimps 12a, 12b, 12c of the separator plates 2a, 2b that face in opposite directions and lie on opposite sides of the bipolar plate 27.

In an electrochemically active region 18, also called active region 18, the first separator plates 2a, on their front side facing the viewer of FIG. 2, have a flow field 17 having first structures 14 for conducting a reaction medium along the outside (or else front side) of the separator plate 2a. These first structures 14 are indicated in FIG. 2 by a multitude of lands and channels that run between the lands and are bounded by the lands. On the front side of the bipolar plates 27 facing the viewer of FIG. 2, the first separator plates 2a additionally each have a distribution region and/or collection region 20. The distribution region and/or collection region 20 comprises structures set up to distribute a medium introduced proceeding from a first of the two passage openings 11b into the adjoining distribution region 20 over the active region 18 and to collect or to combine a medium flowing proceeding from the active region 18 to the second of the passage openings 11b over the collection region 20. The distribution structures of the distribution region and/or collection region 20 are likewise indicated in FIG. 2 by lands and channels that run between the lands and are bounded by the lands.

The sealing crimps 12a-12c are crossed by ducts 13a-13c. For example, the ducts 13a enable passage of coolant between the passage opening 12a and the distribution or collection region 20, such that the coolant arrives in and is removed from the distribution or collection region formed in each case as cavity 19 and the active region 18 between the individual plates 2a, 2b.

In addition, the ducts 13b enable passage of hydrogen from the passage opening 12b through the distribution or collection region 20 on the top side of the upper separator plate 2a to the active region. Ducts 13c enable passage of air, for example, between the passage opening 12c and the distribution or collection region, such that air gets into the distribution or collection region and further to the active region 18 on the underside of the lower separator plate 2b.

The first separator plates 2a each also have a further sealing arrangement in the form of a perimeter crimp 12d that encloses the flow field 17 of the active region 18, the distribution and/or collection region 20 and the passage openings 11b, 11c, and seals them with respect to the passage openings 11a, e.g. with respect to the coolant circuit, and with respect to the environment of system 1. The second separator plates 2b each comprise corresponding perimeter crimps 12d. The structures of the active region 18, the distribution or collection structures of the distribution and/or collection region 20 and the sealing crimps 12a-d are each in one-piece form with the separator plates 2a, 2b and are shaped into the separator plates 2a, 2b, for example in an embossing, hydroforming or thermoforming process.

FIG. 2 also emphasizes two rectangular edge regions 21 of the flow field 17 that are disposed at the ends of the electrochemically active region 18 facing the distribution or collection region 20 and extending in the longitudinal direction over the entire width of the flow field 17, transverse here to the course of the channels in the flow field 17. In the stack of the system 1, these edge regions 21 each serve for accommodation and abutment of a reinforced region of the membrane electrode assemblies (MEA) 10. The edge region 21 is referred to hereinafter as intermediate region 21 or MEA abutment region. The intermediate region 21 is lowered by comparison with the active region 18 (flow field 17) and sometimes also by comparison with the distribution or collection region 20, which means that the separator plates 2 or the bipolar plates 27 have optimal compression in the stack, just like the MEA 10. More details are published in WO 2018/114819 A1, which is incorporated as an integral constituent of this document by reference.

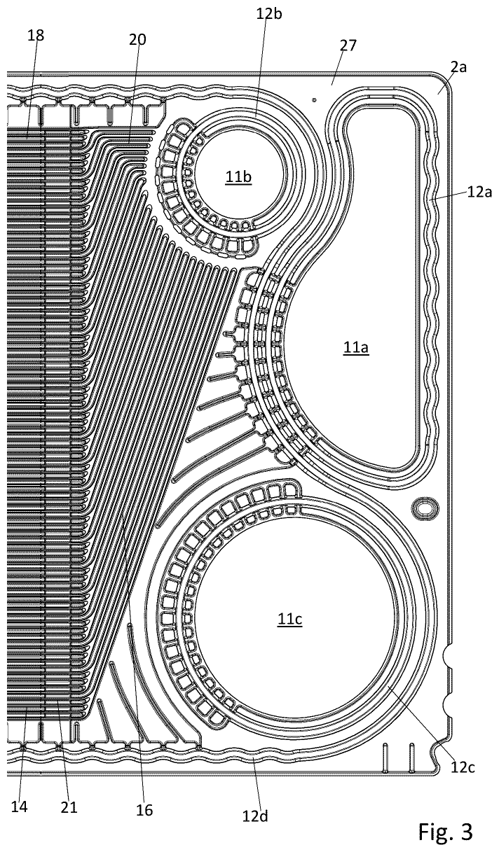

FIG. 3 shows, in somewhat enlarged form, a section of a bipolar plate 27 with the assembled metallic separator plates 2a, 2b. Facing the viewer is the front side of the first separator plate 2a. It is possible to see the passage openings 11a-c in the bipolar plate 27 and the sealing crimps 12a-c arranged around the passage openings 11a-c for sealing of the passage openings 11a-c, which are embossed into the first separator plate 2a. Also apparent here are the channel structures 14, 16 of the active region 18, of the intermediate region 21 and of the distribution or collection region 20. Some of the channels 16 of the active region 18 are continued in the distribution or collection region 20 and end shortly before the passage opening 11b. Other channels 14 of the active region 18 end shortly after the intermediate region 21 and are curved slightly in the direction of the passage opening 11b in their end regions. FIG. 3 is incidentally also shown in the already cited publication WO 2018/114819 A1, as FIG. 2 therein. Therefore, a more detailed description is dispensed with here. Features that are disclosed and elucidated in relation to FIG. 2 shown in WO 2018/114819 A1 may also be combined and claimed in association with the features disclosed in the present document.

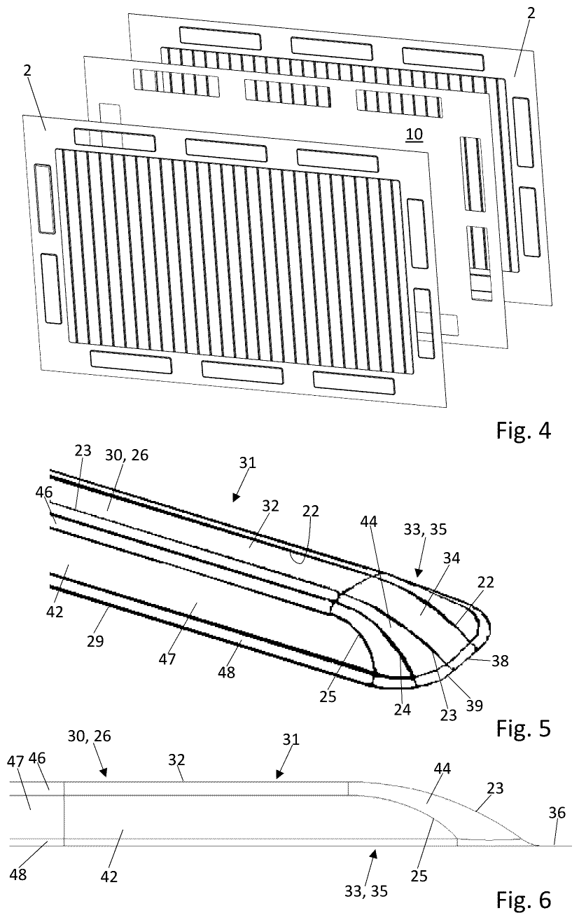

In alternative embodiments, the system 1 may likewise be designed as an electrolyzer (cf. also FIG. 4), electrochemical compressor or redox flow battery. In these electrochemical systems, it is likewise possible to use separator plates. The construction of these separator plates may then correspond to the construction of the separator plates 2 that are elucidated in detail here, even though the media conducted onto or through the separator plates may each be different from the media used for a fuel cell system in an electrolyzer, an electrochemical compressor or a redox flow battery.

For instance, FIG. 4, similarly to FIG. 2, shows two separator plates and an MEA 10 disposed between the separator plates. The separator plates 2 and the MEA 20 of FIG. 4 are part of an electrolyzer.

In an electrochemical system as shown in FIG. 1, it is possible to use either known separator plates 2, as shown in FIGS. 2 to 4, or separator plates 2 according to the present disclosure, as shown in sections from FIG. 5 onward.

Conventionally, ends of the channels 14, 16 are chamfered or circumferentially rounded off in a predominantly constant manner. As a result of the embossing process, the material of the channel base of the separator plate 2 has been bent in two different directions at the ends of the channels. Firstly, the channel base continues in longitudinal extent of the channel 14, 16 such that it has a curvature in this direction. Superposed on this curvature, irrespective of any possible change in the profile direction of the respective channel, is a curvature transverse to the longitudinal direction of the channel 14, 16 or to a virtual line that continues the longitudinal direction. Rather than a channel base that has an essentially flat section spaced apart from its end, the channel base is thus curved more significantly in cross sections transverse to the longitudinal direction with increasing closeness to the end. However, this leads to saving of material, a high degree of forming and significant material thinning at the respective end of the channel 14, 16, which can sometimes result in cracking in this region of the separator plate 2.

The present disclosure was designed in order to at least partly alleviate the problems described above. Details are described with reference to the appended FIGS. 5-13.

FIGS. 5-13 show various views of lands shaped into the separator plate 2. The lands shown in FIGS. 5-13 form channels 30 on the opposite surface of the separator plate 2—e.g. on the coolant side, for example, in the case of a fuel cell—and are also referred to as such hereinafter. The depressions between the lands (channels) that are shown in FIGS. 5-13, in a top view of the reverse side of the separator plate 2, form lands between the channels, for example for the coolant. They are identified and described hereinafter as being viewed from the reverse side. The viewer in FIGS. 5-13 must consequently put themself in the position of viewing from the reverse side of the plane of the drawing. This is also true if the separator plate 2 is configured as a single plate and the reverse side does not form a direct contact surface for a further separator plate, as is frequently the case for an electrolyzer.

FIGS. 5-13 thus show at least one channel 30 having a depth, a longitudinal extent, a channel base 32 and two sidewalls 42. The depth of channel 30 in a first region 31 of the channel is essentially constant in a longitudinal extent. The channel base 32 is essentially flat in the first region 31 of the channel 30. Moreover, the depth of the channel 30 in a transition region 33 of the channel 30 that adjoins the first region 31 decreases along the longitudinal extent, as a result of which a channel base continuation 34 is curved in the transition region 33. The channel base continuation 34 is curved in the transition region 33 such that, when surface lines 22, 23 of the channel base 32 that run parallel to one another along the longitudinal extent of the channel 30 and in the first region 31 are continued in the region of the channel base continuation 34, the surface lines 22, 23 in the region of the channel base continuation 34 likewise run essentially parallel to one another.

The surface lines 22, 23 shown in FIGS. 5-13, for reasons of simplicity and clarity, are drawn in such that they form the boundary between sidewall 42 and channel base 32. These surface lines 22, 23 are thus surface lines of the channel base at a maximum distance from one another. Surface lines that run between these surface lines 22, 23 and in the longitudinal extent of the channel 30 are essentially parallel to one another, both in the first region 31 and in the region of the channel base continuation 34. Moreover, the parallelism of the surface lines may apply to any two of the surface lines of the channel base continuation 34. However, slight deviations from parallelism are possible, as described above.

The present document distinguishes between different types of channels 30: first channels 26 and second channels 28. Reference is sometimes made hereinafter merely to channel 26 or channel 28. Both channels 26, 28 may be regarded as channel 30.

The first channel 26 shown in FIGS. 5-6 has a transition region 33 that forms an end section 35 of the channel 30. The end section 35 adjoins an essentially flat, non-embossed region 36 of the separator plate 2. The flat region 36 may alternatively also be configured as an embossed plateau, and be elevated relative to a non-embossed plane of the separator plate 2, or run parallel to the plane of the separator plate 2.

In the embodiment of FIGS. 5-6, the channel base continuation 34 in the transition region 33 is curved in only one direction, namely in the longitudinal extent of the channel 30. The surface lines 22, 23 in the region of the channel base continuation 34 may have an essentially equal length. A circumferential line 29 of the channel 30 bounds the channel 30 and forms a separating line between channel 30 and further regions of the separator plate 2. The circumferential line 29 of the channel 30 may have a straight section 38 in the region of the channel base continuation 34 or at the end of the channel base continuation.

A curvature of the channel base continuation 34 may be essentially constant here, where a radius of curvature of the channel base continuation 34 may especially be at least 0.1 mm, especially 0.15 mm, especially 0.2 mm, and/or at most 4 mm, especially at most 2.5 mm.

The channel base continuation 34 in the transition region 33 may have a length projected into the plane of the plate of at least 0.1 mm, at least 0.2 mm, and/or at most 4 mm and at most 2 mm, and/or a constant width of at least 0.01 mm, at least 0.05 mm, especially at least 0.08 mm, and/or at most 5 mm, at most 3 mm, at most 2 mm, especially at most 1.8 mm.

The sidewall 42 generally comprises, in the first region of the channel 30, a first curved region 46, a second curved region 48, and a connecting section 47 that extends between the curved regions 46, 48 and connects them to one another. The connecting section 47 may be configured as a flat inclined face. Alternatively, the connecting section 47, as a result of the forming process, may have slight curvature. In the first region 33 of the channel, the curved regions 46, 48 are generally curved in one direction. The radii of curvature of the two curved regions 46, 48 typically differ from one another, and may have illustrative values of 0.1 mm or 0.15 mm in the case of fuel cells or 0.25 mm or 0.4 mm in the case of electrolyzers. The second curved region 48 may adjoin a flat, especially non-embossed, region 36 of the separator plate. This flat region may extend between two adjacent channels 30 and as such be relatively narrow. In a transverse extent of the channel 30, transverse to the longitudinal extent, the first curved region 46 adjoins the channel base 32 and is curved in transverse extent.

In the transition region 33 of the channel 30, the sidewall 42 has sidewall continuations 44. The sidewall continuations 44 in the transition region 33 of the channel 30 are often each curved at least in two directions at least in sections. When surface lines 24, 25 that run parallel to one another along the longitudinal extent of the channel 30 and in the first curved region 46 are continued in the region of the sidewall continuations 44, the surface lines 24, 25 diverge in the region of the sidewall continuations 44 and especially each have a different length. For instance, the length of the surface line 25 is shorter than the surface line 24 by virtue of the greater curvature in this region in two directions. The circumferential line 29 of the channel 30 may have a curved section 39 in the region of the sidewall continuations 44.

Optionally, a radius of curvature of at least one of the sidewall continuations 44 in the direction of the longitudinal extent of the channel 30 is at least 0.1 mm, at least 0.15 mm, especially at least 0.2 mm, and/or at most 1.5 mm, especially at most 1.0 mm. Moreover, a radius of curvature of the sidewall continuation 44 in the direction of the transverse extent of the channel 30 may be at least 0.1 mm, at least 0.15 mm, and/or at most 3 mm, especially at most 1.5 mm.

The embodiment of the channel 30 shown in FIGS. 9 and 10 is similar to the embodiment of FIGS. 5 and 6, and has a somewhat simpler curvature geometry by comparison. The channel base continuation 34 and the sidewall continuations 44 plunge into the plane of the plate such that the channel base continuation 34 is lowered for the same width along a radius, and the radii of the sidewall continuations 44 become ever greater toward the end. No more detailed description will be given here. The embodiment of FIGS. 9 and 10 is especially suitable for use in an electrolyzer.

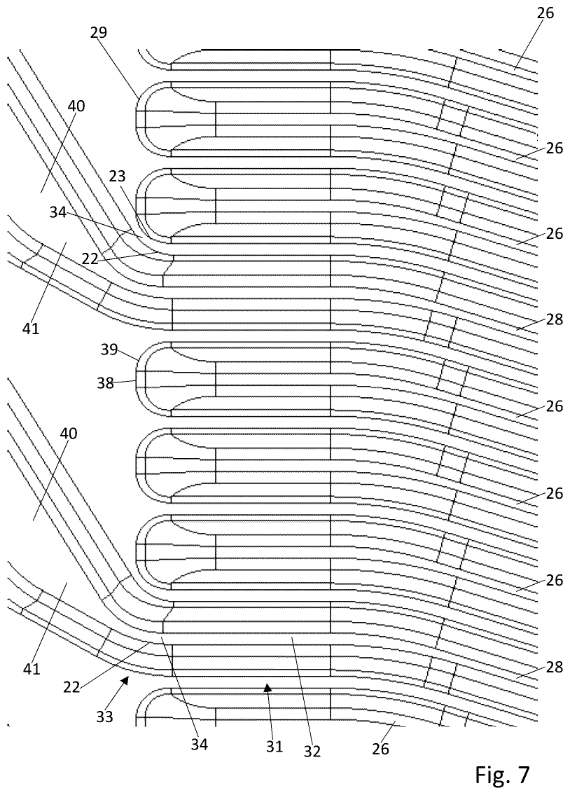

FIGS. 7, 8 and 11-13 show embodiments having a multitude of first channels 26 of the type described above. In addition to the first channels 26 it is also possible to provide second channels 28 that extend alongside the first channels 26 in sections. For instance, FIGS. 7, 8 and 11 show second channels 28.

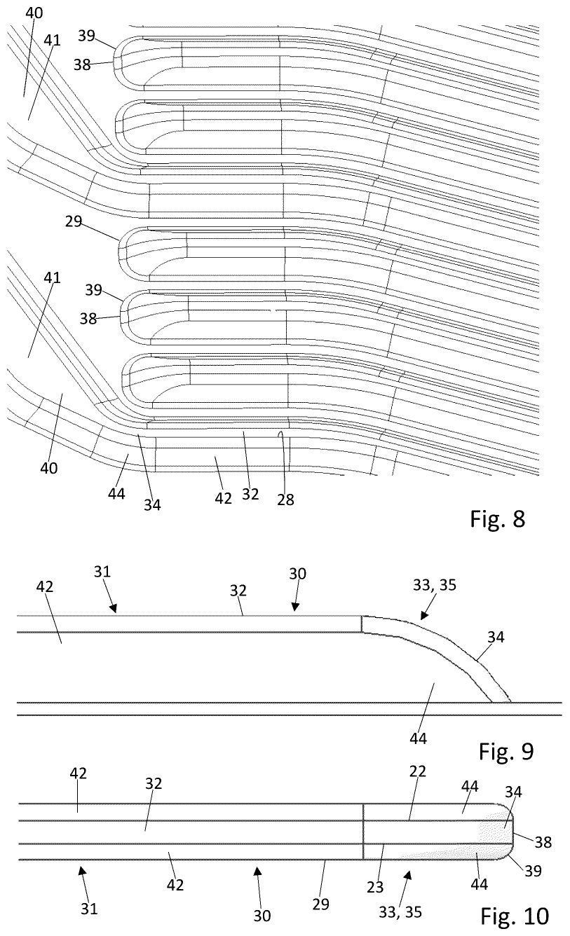

In the embodiment of FIGS. 7 and 8, the transition region 33 may adjoin a further channel 40. The transition region 33 is disposed between the first region 31 of the second channel 28 and the further channel 40, and connects them fluidically to one another. A depth of the further channel 40, at least in a subregion that bounds the transition region 33, may be less than the depth of the channel 28 in the first region 31.

The further channel 40, especially the channel base 41 of the further channel 40, widens out in the working example shown and thus has a greater width than the second channel 28 and the transition region 33, being at least 1.5 times wider, for example. A width is measured here at right angles to the extension direction and at half the depth of the corresponding channel.

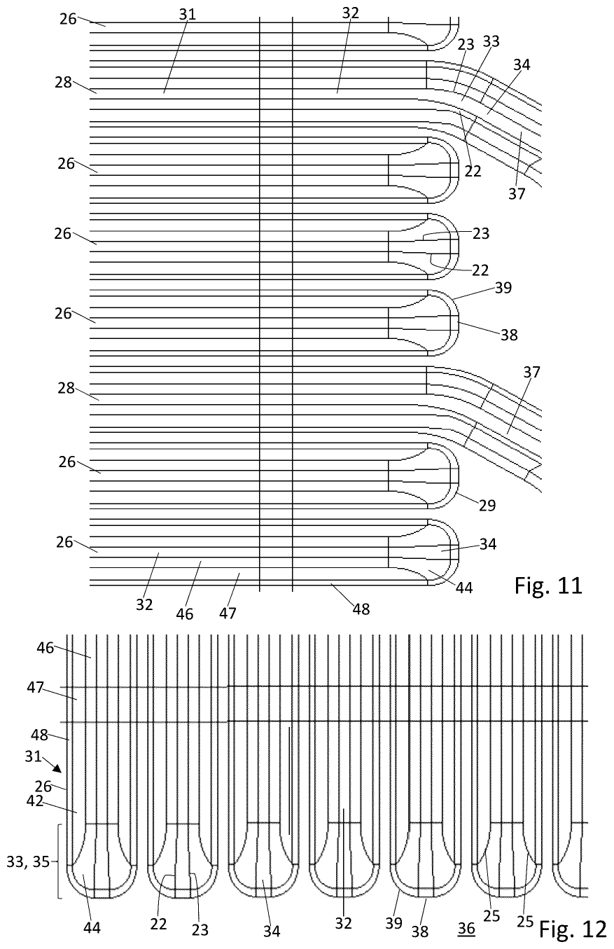

In the embodiment of FIG. 11, the transition region 33 of the second channel 28 adjoins a second region 37 of the channel 28. The transition region 33 is disposed between the first region 31 and the second region 37, and connects them fluidically to one another. A depth of the channel 28 in the second region 37 may be less than the depth of the channel 28 in the first region 31. The first region 31 of the channel 28 and the second region 37 of the channel 28 both extend in a straight line, where the second region of the channel 28 is optionally arranged at an angle of about to the first region 31 of the channel 28. In an alternative embodiment, the two regions 31, 37 are aligned parallel to one another.

The second region 31 and the first region 37 of the second channel 28 thus differ in features including their depth and their alignment. It may also be the case that the channel 28 in the first region 31 has a somewhat smaller width than in the second region 37, for example is narrower by a factor of 1.05 to 1.2.

It is apparent in FIGS. 7, 8 and 11 that the number of first channels 26 is greater than a number of second channels 28. Mutually closest second channels 28 may be separated from one another by at least one first channel 26, and in FIGS. 7, 8 and 11 by three first channels 26. The number of first channels 26 disposed between the second channels 28 may also be higher or lower than three. In FIGS. 7, 8 and 11, the transition region 33 of the second channels 28 in each case has a curved profile along its longitudinal extent. Superposed on the first curvature of the channel base continuation is thus a second curvature due exclusively to the change in direction. Unlike the second curvature of a channel base continuation in the case of conventional separator plates, the changes in the two longitudinal directions of the channel base continuation compensate for one another or run parallel.

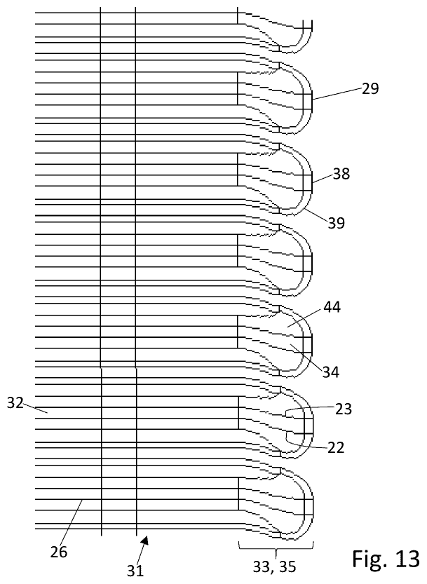

FIG. 12 shows merely first channels 26 that extend in a straight line in their end regions 35 or transition regions 33. FIG. 13 differs in that it depicts first channels 26 that are curved in their transition regions 33. In spite of the curved shape of the transition region, the surface lines 22, 23 in the transition region are essentially parallel to one another.

The above-described channels 26, 28, 30, 40 are typically shaped into the separator plate, generally by hydroforming, thermoforming, embossing, especially vertical embossing or roll embossing.

An electrochemical system 1 according to the present disclosure contains a multitude of stacked separator plates 2 with the channels shown in FIGS. 5-13. Moreover, reference is made to the above description of the electrochemical system 1 of FIG. 1.

Features that are shown in merely one of FIGS. 1-13 may be combined with features of other figures, unless they are mutually exclusive.

1. A separator plate for an electrochemical system, comprising a multitude of mutually parallel and adjacent channels that are designed to guide a fluid at least along a region of the separator plate, wherein the channels each have a depth, a longitudinal extent, a channel base and two sidewalls, wherein the following conditions apply to at least one of the channels:
the depth of the channel in a first region of the channel is essentially constant along the longitudinal extent,
the channel base in the first region of the channel is essentially flat and
the depth of the channel in a transition region of the channel that adjoins the first region decreases along the longitudinal extent, as a result of which a channel base continuation in the transition region is curved,
wherein the channel base continuation in the transition region is curved in such a way that, when surface lines of the channel base that are mutually parallel to one another along the longitudinal extent of the channel and in the first region are continued in the region of the channel base continuation, the surface lines likewise run essentially parallel to one another in the region of the channel base continuation.

2. The separator plate according to claim 1, wherein the following condition is applicable to at least a first channel: the transition region forms an end section of the channel and adjoins an essentially flat, especially non-embossed, region of the separator plate.

3. The separator plate according to claim 1, wherein the following condition is applicable to at least a second channel: the transition region adjoins a second region of the channel or a further channel, is disposed between the first region and the second region or the further channel and connects the two fluidically to one another, wherein a depth of the channel in the second region or a depth of the further channel is lower than the depth of the channel in the first region.

4. The separator plate according to claim 3, comprising a multitude of first channels and a multitude of second channels, wherein at least two mutually closest second channels are separated from one another by at least a first channel.

5. The separator plate according to claim 1, wherein the channel base continuation in the transition region is curved in only one direction.

6. The separator plate according to claim 1, wherein the surface lines in the region of the channel base continuation have an essentially equal length.

7. The separator plate according to claim 1, wherein the channel base continuation is curved in the direction of the longitudinal extent of the channel.

8. The separator plate according to claim 1, wherein a curvature of the channel base continuation is essentially constant, wherein a radius of curvature of the channel base continuation is especially at least 0.1 mm.

9. The separator plate according to claim 1, wherein sidewall continuations of the sidewalls in the transition region of the channel are each curved in at least two directions at least in sections.

10. The separator plate according to claim 9, wherein each sidewall in the first region has a first curved region which, in a transverse extent of the channel, adjoins the channel base transverse to the longitudinal extent and is curved in transverse extent, wherein, when surface lines that are mutually parallel along the longitudinal extent of the channel and in the first curved region are continued in the region of the sidewall continuations, the surface lines diverge in the region of the sidewall continuations and especially each have a different length.

11. The separator plate according to claim 1, wherein the channel base continuation in the transition region has a length projected into the plane of the plate of at least 0.1 mm and/or a constant width of at least 0.01 mm.

12. The separator plate according to claim 9, wherein a radius of curvature of one of the sidewall continuations in the direction of the longitudinal extent of the channel is at least 0.1 mm, wherein a radius of curvature of the sidewall continuation in the direction of the transverse extent of the channel is at least 0.1 mm.

13. The separator plate according to claim 1, wherein the channels are formed into the separator plate.

14. The separator plate according to claim 1, wherein the channel has a straight or curved profile at least in sections along its longitudinal extent in the first region and/or in the transition region.

15. The separator plate according to claim 1, wherein a circumferential line of the channel has a straight section in the region of the channel base continuation.

16. A bipolar plate comprising two mutually connected separator plates according to claim 1.

17. An electrochemical system comprising a multitude of stacked separator plates according to claim 1.

18. An electrochemical system comprising a multitude of stacked bipolar plates according to claim 16.
